(19) United States
(12) Patent Application Publication
(10) Pub. No.: US 2013/0316123 A1
(43) Pub. Date: Nov. 28, 2013

(54) ASSEMBLY INCLUDING A COMPRESSION-MOLDED COMPOSITE COMPONENT HAVING A SANDWICH STRUCTURE AND AT LEAST ONE FASTENER COMPONENT

(71) Applicants: Darius J. Preisler, Macomb, MI (US); Christopher A. Heikkila, Washington Township, MI (US)

(72) Inventors: Darius J. Preisler, Macomb, MI (US); Christopher A. Heikkila, Washington Township, MI (US)

(73) Assignee: GLOBAL IP HOLDINGS, LLC, Sterling Heights, MI (US)

(21) Appl. No.: 13/479,974

(22) Filed: May 24, 2012

(51) Int. Cl. B32B 3/06; B32B 3/26; B32B 3/12; B62D 25/20

(52) U.S. Cl. 428/99; 296/193.07

(57) ABSTRACT

An assembly including a compression-molded composite component having a sandwich structure and at least one fastener component is provided. The composite component has a first outer layer, a second outer layer, and a core positioned between the outer layers. The core has a large number of cavities. The outer layers are bonded to the core by press molding. Each fastener component has a fastener part having a length and width and a mounting part mounting the fastener part to the first outer layer. The mounting part has a pair of holding faces that oppose each other and define a space therebetween. A portion of the first outer layer is positioned in the space in engagement with the faces to prevent the fastener part from moving along its length relative to the first outer layer.

### TECHNICAL FIELD OF THE INVENTION

This invention generally relates to assemblies including compression-molded composite components having sandwich structures and, in particular, to such assemblies which have fastener components mounted in the composite components.

### OVERVIEW

Some compression-molded composites combine a light-weight, low-density core with fiber-reinforced thermoplastic skins or outer layers thereby resulting in a sandwich structure. The resulting composite component has a high stiffness-to-weight ratio thereby making it desirable for use in a wide variety of applications including load-bearing applications. In general, the thicker the core, the higher the load-bearing capacity of the composite component.

As a result of their high stiffness-to-weight ratio and load-bearing capacity, such compression-molded composites have been used as load floors in automotive applications and as skis or snowboards (i.e, sliding boards) in recreational applications.

It is highly desirable to secure hardware and other components to the composite components. In automotive applications, such as rear load-bearing load floors, it is desirable to provide attachment mechanisms at various locations to secure cargo to protect the cargo from sliding, rolling, etc. which tends to damage the cargo as well as other items or structures in the cargo area.

Because of the large forces that cargo as well as individuals can exert on the load floor, any attachment or fastening mechanism must be able to withstand not only large pull-out forces but also large push-in forces. Also, such attachment or fastening mechanisms must be able to withstand large torque forces to prevent the mechanisms from being “torqued out” of or “torqued into” the composite components.

The following U.S. patent documents are related to the present invention: U.S. Pat. Nos. 7,942,475; 7,713,011; 7,419,713; 7,059,815; 6,537,413; 6,050,630; 5,253,962; 5,074,726; 2010/0086728; 2007/0258786 and 2005/0189674.

### SUMMARY OF EXAMPLE EMBODIMENTS

An object of at least one embodiment of the present invention is to provide an assembly including a compression-molded composite component having a sandwich structure and at least one fastener component wherein each fastener component is capable of fastening or securing one or more objects to the composite structure with a relatively high pull-out force.

In carrying out the above object and other objects of at least one embodiment of the present invention, an assembly including a compression-molded composite component having a sandwich structure and at least one fastener component is provided. The composite component has a first outer layer, a second outer layer, and a core positioned between the outer layers. The core has a large number of cavities. The outer layers are bonded to the core by press molding. Each fastener component has a fastener part having a length and width and a mounting part mounting the fastener part to the first outer layer. The mounting part has a pair of holding faces that oppose each other and define a space therebetween. A portion of the first outer layer is positioned in the space in engagement with the faces to prevent the fastener part from moving along its length relative to the first outer layer.

The holding faces may be annular holding faces, the space may be an annular space and the portion of the first outer layer may be an annular portion.

The length of the fastener part may be greater than the width of the first outer layer but less than the width of the composite component.

The fastener part may be cylindrical wherein the cylindrical fastener part has an axis defined as being central to the fastener part.

At least one of the holding faces may have a set of locking formations spaced about the axis of the fastener part to prevent rotary movement of the fastener component relative to the first outer layer.

The holding faces may be annular holding faces wherein the annular holding faces are oriented to face axially along the axis.

The fastener part may be threaded such as internally threaded.

The outer layers may be fiber-reinforced thermoplastic layers.

The first outer layer may be a load-bearing layer and the composite component may be a vehicle floor panel.

The core may be a cellular core.

The core may have a honeycomb structure.

The assembly may further include an opening which extends completely through the first outer layer and at least partially extends through the core towards the second outer layer wherein the mounting part mounts the fastener component in the opening.

The opening may be a circular opening and the fastener component may be a generally cylindrical component.

Further in carrying out the above object and other objects of the at least one embodiment of the present invention, an assembly including a compression-molded composite component having a sandwich structure and at least one fastener component is provided. The composite component has a first outer layer having a circular opening which extends completely through the layer, a second outer layer, and a core positioned between the outer layers and having a large number of cavities. The outer layers are bonded to the core by press molding. Each fastener component is generally cylindrical and has a cylindrical, threaded fastener part having a length, a width and an axis defined as being central to the fastener part and a mounting part mounting the fastener part in the opening in the first outer layer. The mounting part has a pair of annular holding faces that oppose each other and are oriented to face axially along the axis. The holding faces define an annular space therebetween. An annular portion of the first outer layer is positioned in the space in engagement with the faces to prevent the fastener part from moving along its axis relative to the first outer layer.

Still further in carrying out the above object and other objects of at least one embodiment of the present invention, a vehicle floor panel assembly is provided. The assembly includes a compression-molded composite component having a sandwich structure and at least one fastener component. The composite component has a load-bearing, first outer layer having a circular opening which extends completely through the layer, a second outer layer, and a core positioned between the outer layers and having a large number of cavities. The outer layers are bonded to the core by press molding. Each fastener component is generally cylindrical and has a cylindrical, threaded fastener part having a length, a width and an axis defined as being central to the fastener part and a mounting part mounting the fastener part in the opening in the first outer layer. The mounting part has a pair of annular holding faces that oppose each other and are oriented to face axially along the axis. The holding faces define an annular space therebetween. An annular portion of the first outer layer is positioned in the space in engagement with the faces to prevent the fastener part from moving along its axis relative to the first outer layer.

Each of the holding faces may have a set of locking formations spaced about the axis of the fastener part to prevent rotary movement of the fastener component about the axis relative to the first outer layer.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### BRIEF DESCRIPTION OF THE DRAWINGS

FIG. 1 is an environmental view, partially broken away, of a load floor assembly constructed in accordance with at least one embodiment of the present invention and positioned at the rear of an automotive vehicle;

FIG. 2 is a view, partially broken away and in cross section, taken along lines 2-2 of FIG. 1 and showing a fastener component mounted in a hole formed through a first outer layer of a composite component of the assembly;

FIG. 3 is an end view of the fastener component of FIG. 2 prior to insertion in the composite component;

FIG. 4 is a side elevational view of the fastener component prior to insertion; and

FIG. 5 is a sectional view of the fastener component taken along lines 5-5 of FIG. 4.

### DETAILED DESCRIPTION OF EXAMPLE EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

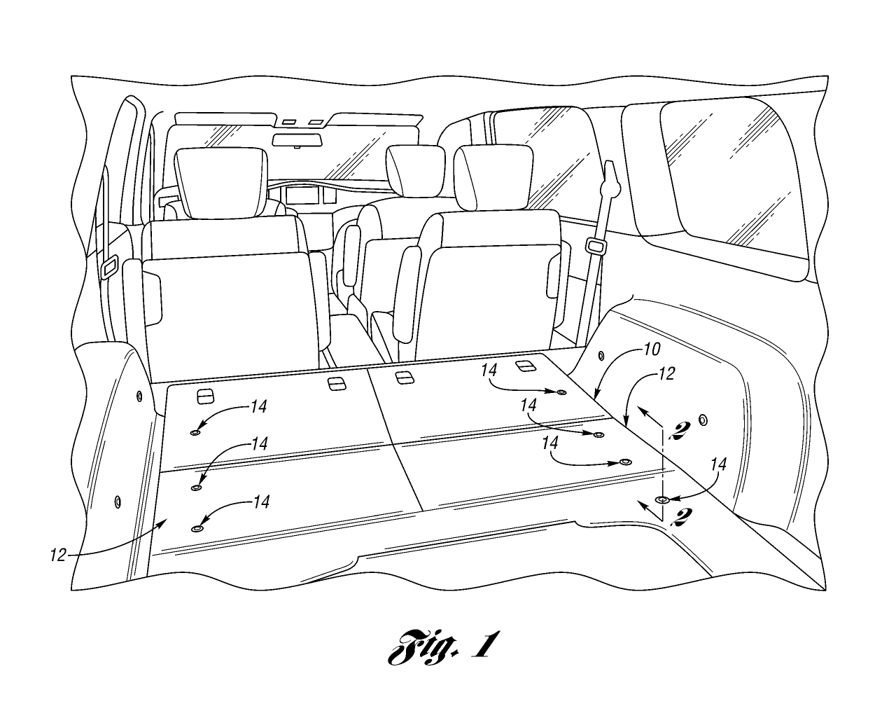

Referring now to the drawing figures, FIG. 1 shows a vehicle floor panel assembly such as a load floor assembly, generally indicated at 10, positioned or supported at the rear of an automotive vehicle. The assembly 10 includes one or more compression-molded composite components, generally indicated at 12, having a composite structure and at least one, and, preferably, a plurality of fastener components, each of which is generally indicated at 14.

The composite component 12 includes a load-bearing first outer layer, generally included at 16, a second outer layer generally included at 18, and a core, generally included at 20, between the outer layers 16 and 18 and having a large number of cavities 22. The outer layers 16 and 18 are bonded to the core 20 by press molding typically after pre-heating the outer layers 16 and 18. The outer layers 16 and 18 are preferably fiber-reinforced thermoplastic layers. The thermoplastic may be a polyolefin such as polypropylene. The thermoplastic may also be polyurethane. The fiber-reinforcement may be a glass mat, a natural fiber mat, a woven or non-woven mat.

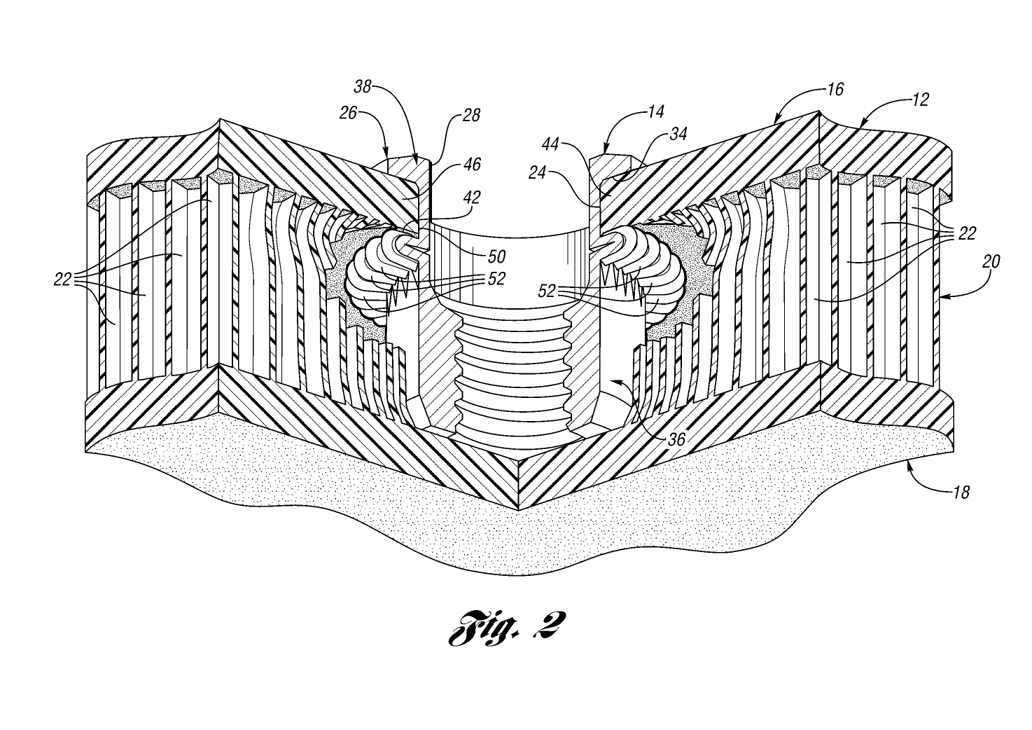

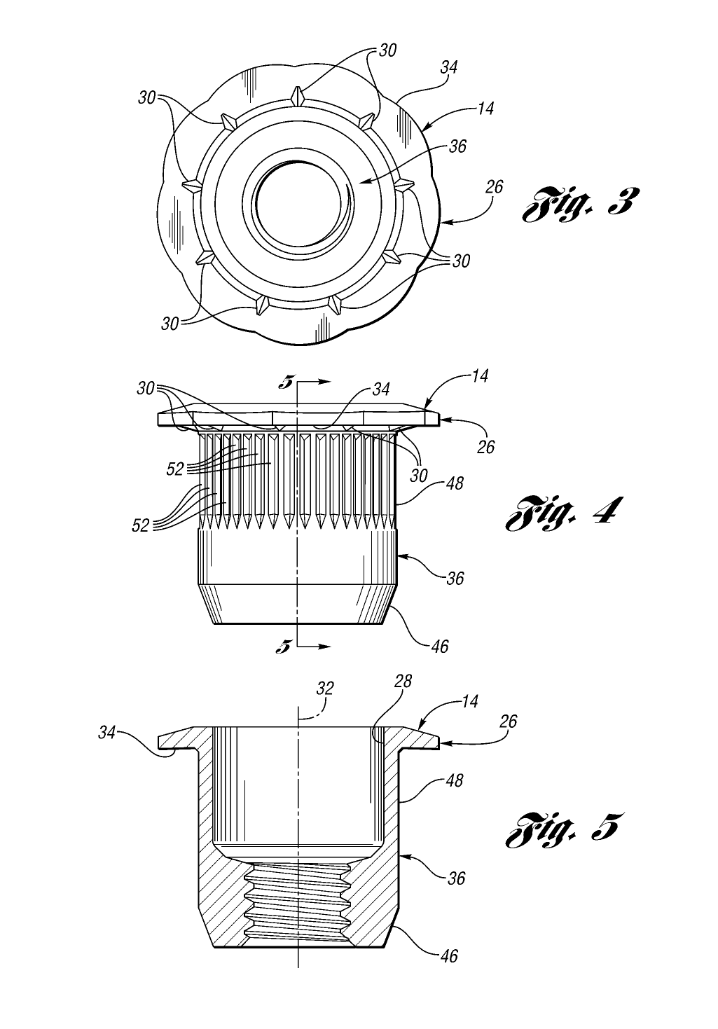

The core 20 may be a cellular core having a thermoplastic honeycomb structure as shown in FIG. 2. The core 20 may also be made of polypropylene honeycomb, aluminum honeycomb, balsa and polyurethane foam. The resulting composite component 12 typically includes a lightweight, low density core such as the core 20 together with fiber-reinforced thermoplastic skins or layers such as the layers 16 and 18.

The composite component 12 may be compression or press molded using a variety of technologies which use a low temperature, compression molding apparatus. For example, the core 20 and the layers 16 and 18 are preferably generally of the type shown in U.S. patent documents U.S. Pat. Nos. 6,537,413; 6,050,630; and 2005/0189674.

After compression or press molding, at least one hole and, preferably, a plurality of holes 24 are formed in the composite component 12 such as by cutting through the first outer layer 16, through the core 20 right up to but not through the second outer layer 18. A rivot-like fastener such as the fastener component 14 is positioned in each of the holes 24. Each of the fastener components 14 is generally of the type shown in U.S. patent publications U.S. Pat. No. 7,713,011 and 2007/0258786 wherein the preferred fastener component is called an M4 insert, installed by use of a hydro-pneumatic tool both of which are available from Sherex Fastening Solutions LLC of New York. One of the fastener components 14 is illustrated in FIGS. 3-5 prior to installation wherein during installation an outer sleeve of the fastener component 14 is deformed, the deformed component 14 being shown in FIG. 2.

The fastener component 14 typically has a relatively large annular flange, generally included at 26, an open end 28 and a plurality of integrally formed locking formations or wedges 30 circumferentially spaced about an axis 32 of the component 14 on an annular face 34 of the flange 26 to prevent rotary motion of the fastener component 14 relative to the first outer layer 16 after installation. The wedges 30 grip into the outer surface of the first outer layer 16 after the fastener component 14 is attached to the first outer layer 16.

In general, each fastener component 14 includes a cylindrical fastener portion or part, generally included at 36, having a length and width, and a mounting portion or part, generally indicated at 38, for mounting the fastener part 36 to the first outer layer 16. The mounting part 38 includes the annular holding face 34 and an annular holding face 42 that oppose each other and define an annular space 44 therebetween. An annular portion 46 of the first outer layer 16 is positioned in the space 44 in engagement with the faces 34 and 42 to prevent the fastener part 36 from moving along its length or axis 32 relative to the first outer layer 16. The axis 32 is generally central to the fastener part 36 and the annular holding faces 34 and 42 are oriented to face axially along the axis 32.

The fastener part 36 is threaded such as being internally threaded. By being internally threaded, an externally threaded part of the above-noted tool is threadedly secured to the fastener part 36 and then rotated to move a distal end 46 of the fastener part 36 towards the open end 28 of the part 36 thereby deforming an outer tubular sleeve 48 of the fastener part 36 to form a second annular flange 50 having the holding face 42. Preferably, the outer surface of the sleeve 48 includes a plurality of circumferentially spaced knurls 52 which form locking formations on the holding face 42 of the annular flange 50 to further prevent rotary motion of the fastener component 24 relative to the first outer layer 16.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An assembly comprising:
a compression-molded composite component having a sandwich structure, the component including:
a first outer layer;
a second outer layer; and
a core positioned between the outer layers and having a large number of cavities wherein the outer layers are bonded to the core by press molding; and
at least one fastener component, each fastener component including:
a fastener part having a length and width; and
a mounting part mounting the fastener part to the first outer layer, the mounting part having a pair of holding faces that oppose each other and define a space therebetween, a portion of the first outer layer being positioned in the space in engagement with the faces to prevent the fastener part from moving along its length relative to the first outer layer.

2. The assembly as claimed in claim 1, wherein the holding faces are annular holding faces, the space is an annular space and the portion of the first outer layer is an annular portion.

3. The assembly as claimed in claim 1, wherein the length of the fastener part is greater than the width of the first outer layer but less than the width of the composite component.

4. The assembly as claimed in claim 1, wherein the fastener part is cylindrical and wherein the cylindrical fastener part has an axis defined as being central to the fastener part.

5. The assembly as claimed in claim 4, wherein at least one of the holding faces has a set of locking formations spaced about the axis of the fastener part to prevent rotary movement of the fastener component relative to the first outer layer.

6. The assembly as claimed in claim 4, wherein the holding faces are annular holding faces and wherein the annular holding faces are oriented to face axially along the axis.

7. The assembly as claimed in claim 1, wherein the fastener part is threaded.

8. The assembly as claimed in claim 7, wherein the fastener part is internally threaded.

9. The assembly as claimed in claim 1, wherein the outer layers are fiber-reinforced thermoplastic layers.

10. The assembly as claimed in claim 1, wherein the first outer layer is a load-bearing layer.

11. The assembly as claimed in claim 10, wherein the composite component is a vehicle floor panel.

12. The assembly as claimed in claim 1, wherein the core is a cellular core.

13. The composite component as claimed in claim 1, wherein the core has a honeycomb structure.

14. The assembly as claimed in claim 1, further comprising an opening which extends completely through the first outer layer and at least partially extends through the core towards the second outer layer wherein the mounting part mounts the fastener component in the opening.

15. The assembly as claimed in claim 14, wherein the opening is a circular opening and the fastener component is a generally cylindrical component.

16. An assembly comprising:
a compression-molded composite component having a sandwich structure, the component including:
a first outer layer having a circular opening which extends completely through the layer;
a second outer layer; and
a core positioned between the outer layers and having a large number of cavities wherein the outer layers are bonded to the core by press molding; and
at least one fastener component, each fastener component being generally cylindrical and including:
a cylindrical, threaded fastener part having a length, a width and an axis defined as being central to the fastener part; and
a mounting part mounting the fastener part in the opening in the first outer layer, the mounting part having a pair of annular holding faces that oppose each other and are oriented to face axially along the axis, the holding faces defining an annular space therebetween, an annular portion of the first outer layer being positioned in the space in engagement with the faces to prevent the fastener part from moving along its axis relative to the first outer layer.

17. The assembly as claimed in claim 16, wherein the length of the fastener part is greater than the width of the first outer layer but less than the width of the composite component.

18. The assembly as claimed in claim 16, wherein each of the holding faces has a set of locking formations spaced about the axis of the fastener part to prevent rotary movement of the fastener component about the axis relative to the first outer layer.

19. A vehicle floor panel assembly comprising:
a compression-molded composite component having a sandwich structure, the component including:
a load-bearing, first outer layer having a circular opening which extends completely through the layer;
a second outer layer; and
a core positioned between the outer layers and having a large number of cavities wherein the outer layers are bonded to the core by press molding; and
at least one fastener component, each fastener component being generally cylindrical and including:
a cylindrical, threaded fastener part having a length, a width and an axis defined as being central to the fastener part; and
a mounting part mounting the fastener part in the opening in the first outer layer, the mounting part having a pair of annular holding faces that oppose each other and are oriented to face axially along the axis, the holding faces defining an annular space therebetween, an annular portion of the first outer layer being positioned in the space in engagement with the faces to prevent the fastener part from moving along its axis relative to the first outer layer.

20. The assembly as claimed in claim 19, wherein at least one of the holding faces has a set of locking formations spaced about the axis of the fastener part to prevent rotary movement of the fastener component about the axis relative to the first outer layer.
